(19) United States
(12) Patent Application Publication
(10) Pub. No.: US 2006/0133091 A1
(43) Pub. Date: Jun. 22, 2006

(54) Buoyant dynamic ornament

(76) Inventor: Jui-An Tsai, Tao Yuan Hsien (TW)

Correspondence Address: DAVID E. DOUGHERTY;Dennison, Schultz, Dougherty & MacDonald, Suite 105, 1727 King Street, Alexandria, VA, 22314-2700, US

(21) Appl. No.: 11/014,876

(22) Filed: Dec. 20, 2004

(51) Int. Cl. F21V 9/12; F21V 5/00

(52) U.S. Cl. 362/318

(57) ABSTRACT

A buoyant dynamic ornament includes a water storage tank, a transparent buoyant tank, a plurality of floats, and a water level control. By the water level control, the water flowing in and out the water storage tank and the buoyant tank is controlled and the water level varies so as to provide the floats buoyancy. Thus the floats rise or sink according to the variation of water level. At the same time, the figures or light on the floats also moves up and down. The dynamic decorative effect is achieved.

### BACKGROUND OF THE INVENTION

The present invention relates to a buoyant dynamic ornament, especially to an ornament that uses the water level inside a transparent buoyant tank to control the buoyancy as well as the movement of the floats. Thus the dynamic decorative effect is achieved.

The common fluid dynamic ornament includes a flotage between the two kind of liquids and devices with natural flowing water such as fountain ornaments, waterfalls. No of them is designed in the principle of buoyancy. However, the present invention has not only dynamic decorative effect but also effect of scientific education.

### SUMMARY OF THE INVENTION

It is therefore a primary object of the present invention to provide a buoyant dynamic ornament that is composed by a water storage tank, a transparent buoyant tank, a plurality of floats, and a water level control. By the water level control, the water flowing in and out the water storage tank and the buoyant tank is regulated and the water level varies so as to provide the floats buoyancy. Thus the floats rise or sink according to the variation of water level and the figures or light on the floats also moves up and down so as to achieve dynamic decorative effect.

### BRIEF DESCRIPTION OF THE DRAWINGS

The structure and the technical means adopted by the present invention to achieve the above and other-objects can be best understood by referring to the following detailed description of the preferred embodiments and the accompanying drawings, wherein

FIG. 1 is a perspective view of an embodiment in accordance with the present invention;

FIG. 2 is a cross sectional view of the embodiment in FIG. 1;

FIG. 3 is an explosive view of the embodiment in FIG. 2;

FIG. 4 is a schematic drawing of the present invention while floats are rising;

FIG. 5 is a schematic drawing of the present invention while floats are sinking;

FIG. 6 is a schematic view of a lighting device in accordance with the present invention.

### DETAILED DESCRIPTION OF THE PREFFERED EMBODIMENT

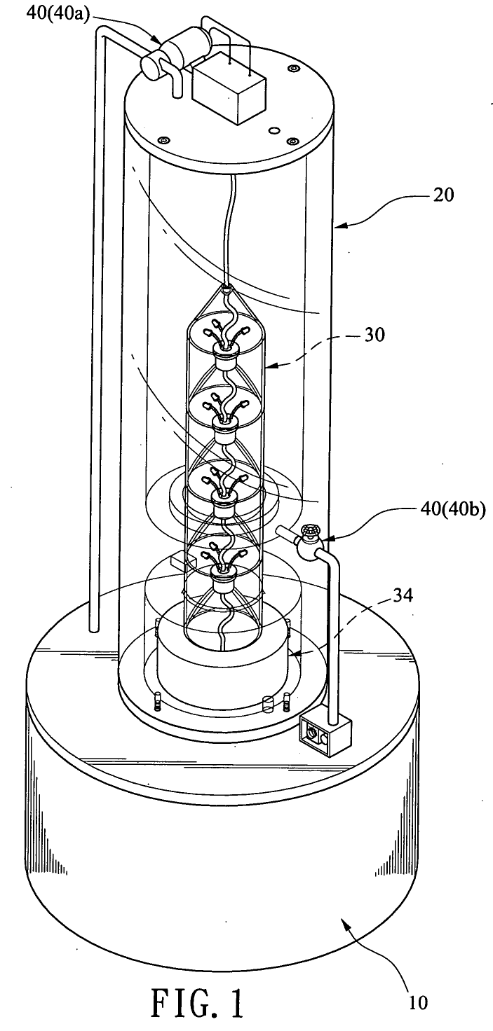

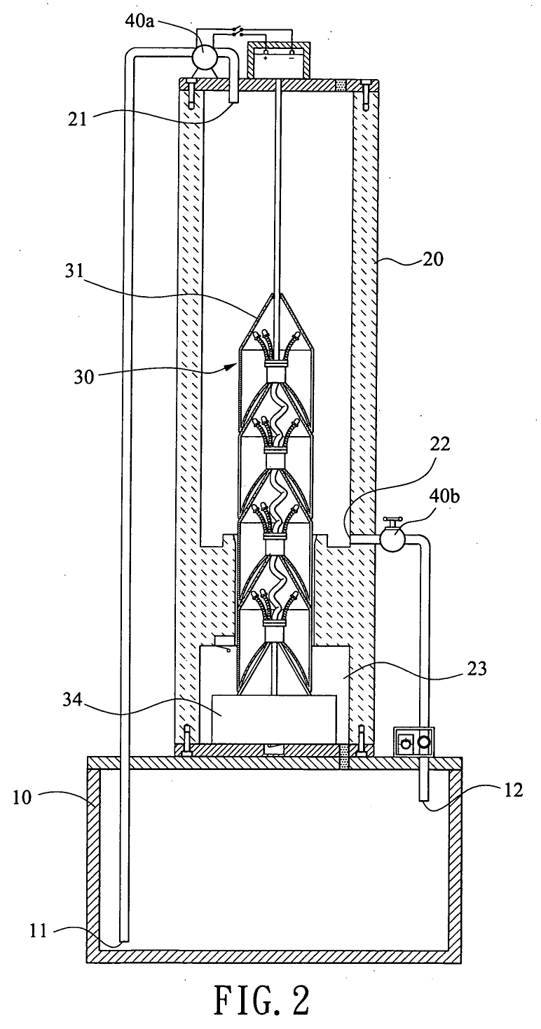

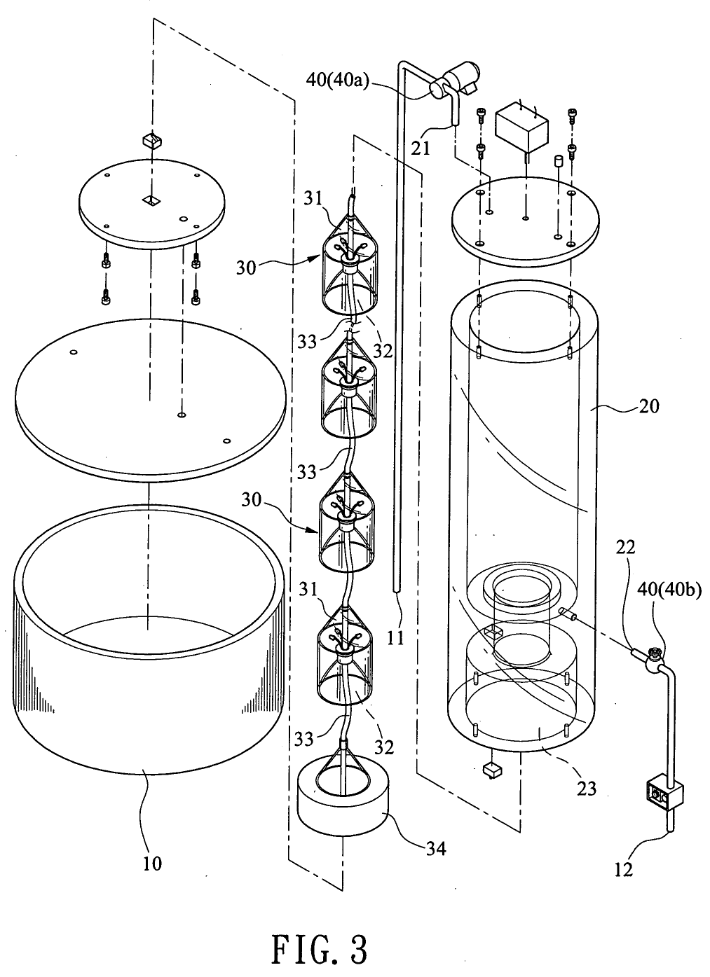

Refer to FIG. 1, FIG. 2 & FIG. 3, a buoyant dynamic ornament in accordance with the present invention includes a water storage tank 10, a transparent buoyant tank 20, a plurality of floats 30, and a water level control 40. The water storage tank 10 with an outlet 11 and an inlet 12 is used to store and recycle fluid (water). The inlet 11 and the outlet 12 are connected to the buoyant tank 20.

The buoyant tank 20 is a transparent container with a certain depth for displaying the inner side. An inlet 21 and an outlet 22 are arranged on the buoyant tank 20. The inlet 21 is disposed on the higher position such as the top of the buoyant tank 20 and is connected with the outlet 11 of the water storage tank 10. By the water level control 40 a, water flow through the inlet 11 of the water storage tank 10, the inlet 21, and then into the buoyant tank 20. The outlet 22 is arranged on the lower position such as the bottom of the buoyant tank 20 and is connected with the inlet 12 of the water storage tank 10. By the water level control 40 b, water is discharged through the outlet 22 and then is returned to the water storage tank 10 through the inlet 12. Thus the water is in circulation.

The water level control (40a, 40b) is disposed between the water storage tank 10 and the buoyant tank 20 and is composed of a water pump and a valve. By controlling the water amount in and out the water storage tank 10 and the buoyant tank 20, the water level inside the buoyant tank 20 varies according to users' needs.

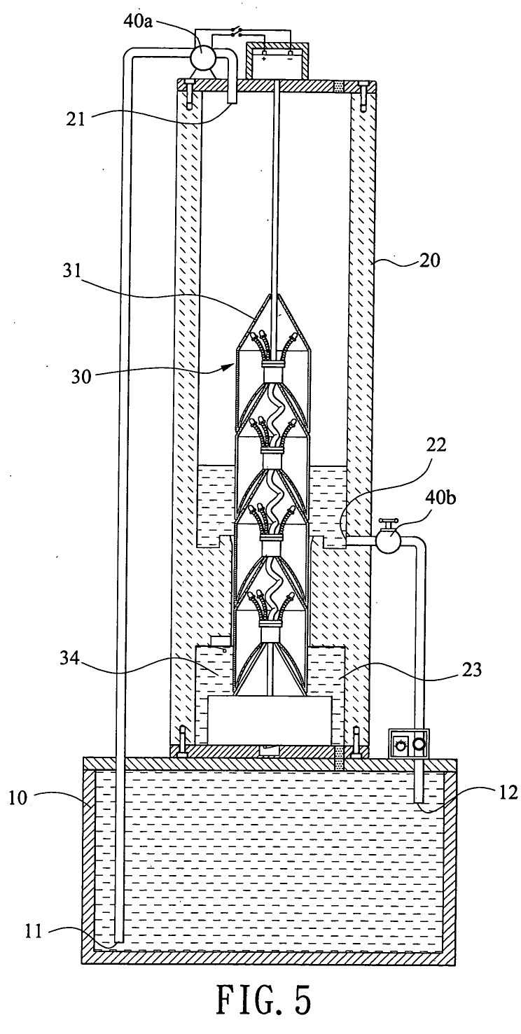

The several floats 30 are arranged inside the transparent buoyant tank 20. Each of the floats 30 is a hollow closed container that can produce buoyancy. There is no limit on the shape of the float 30. In order to reduce fluid resistance while the float 30 is rising, the float 30 is designed with a conic head 31 and a tail 32 with a slot. The shape of the slot corresponds to the conic head 31 so that the conic head of a lower float matches the tail slot of an upper float. A soft and tiny tube 33 with certain length is used to connect the two contiguous floats 30. When there is no water or not enough water inside the buoyant tank 20, a plurality of floats 30 don't have enough buoyancy to float. Thus the floats 30 are stacked with each other and located at the bottom of the buoyant tank 20, as shown in FIG. 5. While the floats 30 are infused with enough water or achieves full water level, then each of the floats 30 has enough buoyancy to rise in sequence and distributes inside the buoyant tank 20. A buoyant stopper 34 is disposed under the lowest float 30 and is enclosed inside a hollow guiding slot 23. When the buoyant stopper 34 is drawn and is risen on top of the hollow guiding slot 23 by the buoyancy of the floats 30, the buoyant stopper 34 contacts a water level sensor (not shown in figure) thus the water level sensor sends signals to keep the water level control 40 b in open. Thus the water inside the buoyant tank 20 flows into the water storage tank 10 through the outlet 22.

When water is drained and the buoyancy of the floats 30 disappears, the buoyant stopper 34 sinks to the bottom of the hollow guiding slot 23 and thus contacts another water level sensor (not shown in figure). Then the water level sensor sends signals to keep the water level control 40 a in open. Therefore, the water flows from the water storage tank 10, through the inlet 21 and into the buoyant tank 20.

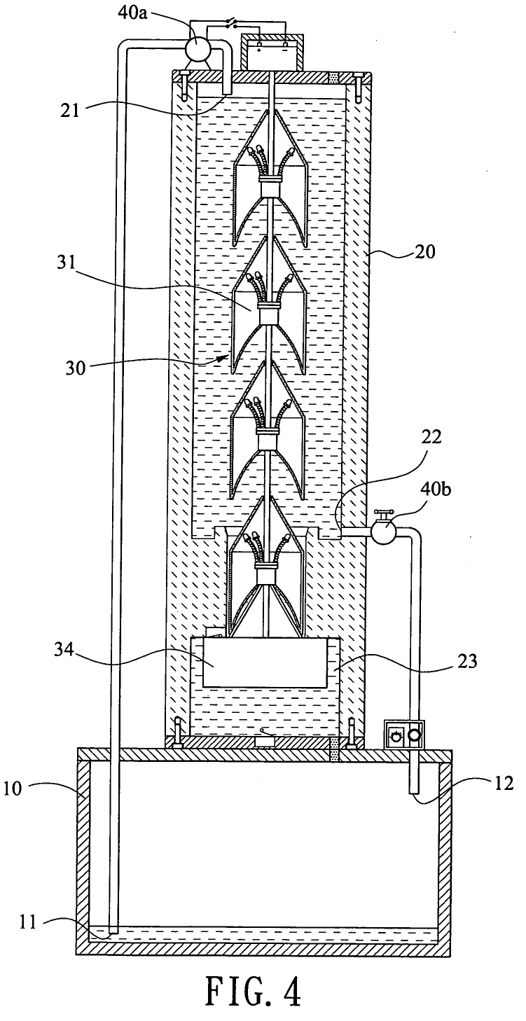

In usage, the water level control 40 is used to make the water flow from the water storage tank 10 to the buoyant tank 20. Thus the floats 30 inside the buoyant tank 20 rise gradually due to the increasing buoyancy and then are separated one from another, as shown in FIG. 4. When the floats 30 are all separated from each other completely, operate the water level control 40 to make water return to the water storage tank 10 from the buoyant tank 20. Thus the buoyancy of the floats 30 disappear and the floats 30 sink gradually and get stacked on the bottom of the buoyant tank 20, as shown in FIG. 5. The water inside the device is in circulation.

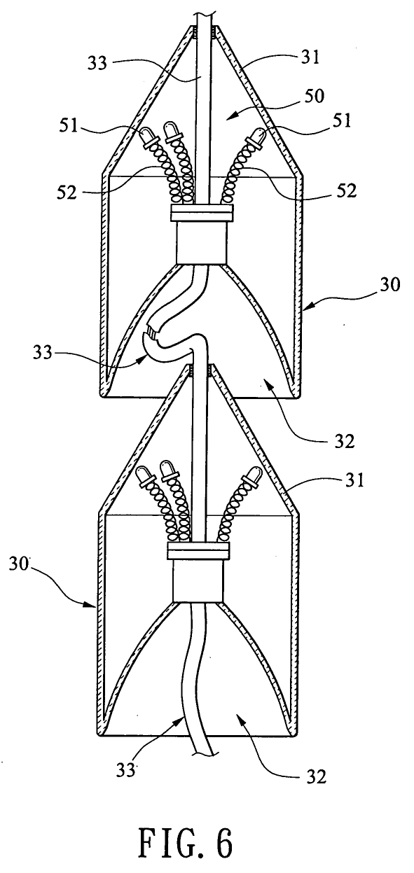

Refer to FIG. 6, a plurality of figures, laser sticker (not shown in figure) or lighting device 50 is disposed inside each of the floats 30. The lighting device 50 is composed of at least one light emitting diode (LED) 51. There is no limit on the number or the color of LED. Each LED 51 is arranged on the end of a spring 52 so as to make the LED 51 shake or dangle while the floats 30 rise or sink. Thus the dynamic visual effect of the lighting device 50 is increased. Moreover, wire of the lighting device 50 inside each float 30 is connected to the buoyant stopper 34 by the soft and tiny tube 33 between the two contiguous floats 30. Then through the outside power source connected to the buoyant stopper 34, users can operate

What is claimed is:

1. A buoyant dynamic ornament in accordance comprising
a water storage tank, a transparent buoyant tank, a plurality of floats, and a water level control,
wherein the water storage tank for storing and recycling water having an outlet and an inlet, each is connected to the buoyant tank respectively;
the buoyant tank having an inlet and an outlet is a transparent container with certain depth; the inlet of the buoyant tank is connected to the outlet of the water storage tank and water is drained from the outlet of the water storage tank and then through the inlet of the buoyant tank, into the buoyant tank by the operation of the water level control; the outlet of the buoyant tank is connected to the inlet of the water storage tank and water flows from the outlet of the buoyant tank, through the inlet of the water storage tank, into the water storage tank; thus water is in circulation;
the water level control is disposed between the water storage tank and the buoyant tank and is composed of a water pump and a valve; by regulating the water amount in and out the water storage tank and the buoyant tank, the water level inside the buoyant tank changes; the floats are hollow closed containers and are distributed inside the buoyant tank; a soft and tiny tube with certain length is used to connect two contiguous floats;
the water level control is used to make the water flow from the water storage tank to the buoyant tank, thus the floats inside the buoyant tank rise gradually due to the increasing buoyancy and then are separated one from another; when the floats are all separated from each other completely, by the water level control, water returns back to the water storage tank from the buoyant tank, thus the buoyancy of the floats disappear and the floats sink gradually and get stacked on the bottom of the buoyant tank.

2. The buoyant dynamic ornament as claimed in claim 1, wherein the float is designed with a conic head and a tail with a slot; the shape of the slot corresponds to the conic head so that the conic head of a lower float matches the tail slot of an upper float.

3. The buoyant dynamic ornament as claimed in claim 1, wherein a buoyant stopper is arranged under the lowest float and is moving inside a hollow guiding slot on the bottom of the buoyant tank.

4. The buoyant dynamic ornament as claimed in claim 3, wherein the a water level sensor is disposed on the top of the hollow guiding slot; when the buoyant stopper rises to the top of the hollow guiding slot and contacts the water level sensor, the water level sensor sends signals to the water level control.

5. The buoyant dynamic ornament as claimed in claim 3, wherein a water level sensor is disposed on the bottom of the hollow guiding slot; when the buoyant stopper sinks to the bottom of the hollow guiding slot and contacts the water level sensor, the water level sensor sends signals to the water level control.

6. The buoyant dynamic ornament as claimed in claim 1, wherein the float is a transparent closing container with decorative figures or lighting devices therein.

7. The buoyant dynamic ornament as claimed in claim 6, wherein the lighting device is made of at least one light emitting device and the light emitting device is with various colors.

8. The buoyant dynamic ornament as claimed in claim 7, wherein the light emitting device is disposed on the end of a spring so as to have effects of dangling.

9. The buoyant dynamic ornament as claimed in claim 6, wherein the lighting device is electrically connected to each other through the soft and tiny tube between the two contiguous floats.

10. The buoyant dynamic ornament as claimed in claim 9, wherein the lighting device inside the float is electrically connected to the buoyant stopper, and then through the buoyant stopper is connected to external power source.
